(19) United States
(12) Patent Application Publication
(10) Pub. No.: US 2015/0058427 A1
(43) Pub. Date: Feb. 26, 2015

(54) Limited Area Temporary Instantaneous Network

(71) Applicant: Jean Rene' Grignon, Paris (FR)

(72) Inventor: Jean Rene' Grignon, Paris (FR)

(21) Appl. No.: 13/974,910

(22) Filed: Aug. 23, 2013

(51) Int. Cl. H04W 4/02

(52) U.S. Cl. CPC H04W 4/02
USPC 709/206; 709/204

(57) ABSTRACT

Social interaction between users in a mobile computing environment is facilitated by obtaining, from a plurality of mobile device users seeking connection to other users, via each user's respective mobile device, each user's self-identified interest as to which a connection is sought, and self-identified geographic area within which other users are desired to be engaged for a connection. A platform compares the self-identified interests and self-identified geographic areas of at least two users to identify two or more matching users, the matching users having expressed matching interests, and having overlapping geographic areas of interest, and then enables the two or more matching users to commence communication via their respective mobile devices, to facilitate further social interaction.

### TECHNICAL FIELD

This application generally relates to a social networking service enabling users of mobile computing devices present in the same area and having a common interest to instantaneously participate in a “Limited Area Temporary Instantaneous Network” or “LATIN”.

### BACKGROUND OF THE INVENTION

Worldwide use of mobile devices and social networks has continued to expand with the use of mobile computing devices (smart phones, tablets running mobile operating systems) now overtaking fixed computing devices (desktop or laptop computers running PC operating systems). Social networks allow immediate communication regarding events and activities, and make it easier than ever to identify persons with similar interests spread over a wide area and communicate and interact with those persons over distance with either a conversational immediacy (via SMS or other text messaging methods) or in the form of long term correspondence.

Unfortunately, mobile computing systems and social networks have not, to date, enabled the identification of persons with similar interests over a limited area and location or communication with those persons on an immediate time scale. Particularly when identifying and connecting to strangers in or close to a limited area, existing social networks require a lengthy process of cross-authentication and do not readily aid in the identification of points of current common interest which can trigger immediate interaction between persons on a common subject of interest. Social networks often connect persons either based upon prior acquaintance or common mutual acquaintance, as a proxy for actual interests, and thus can be ineffective in connecting complete strangers that have an immediate/current common interest but no common acquaintances, or strangers likely to have immediate/current common interests identifiable based on accumulations of personal information on the persons (“profiles” of these persons).

U.S. Patent Application Publication 2011/0142016 of Chatterjee describes an “Ad Hoc Networking Based on Content and Location”. This system proposes to create ad hoc networks of mobile device users that are within a “social networking distance” of each other, based upon “common interests and experiences” which is identified from content used by the mobile device, e.g., usage of the mobile device, content downloaded, places traveled, pictures shared, etc. While this application does seek to connect persons who do not have a prior acquaintance, the proposed method of doing so is likely to be perceived as invasive, as the content and activity on a mobile device is personal in nature and not necessarily intended to be shared with others or intended to be a basis for connecting to other persons.

Accordingly, there remains a need for a social networking system that can connect persons for immediate interaction despite the lack of prior acquaintance, based upon current common interests, while preserving each participant's sense of privacy and control over their personal activities and information.

### SUMMARY OF THE INVENTION

In accordance with principles of the present invention, this need is met by a social networking system in which users seeking connection to other users self-identify one or more interests as to which a connection is sought, and self-identify a geographic area (“GA”) within which other users are desired to be engaged for a connection. The system then seeks users identifying a matching interest, and having an overlapping geographic area of interest.

In particular embodiments, a user specifies an interest by way of a natural language text entry. The interests of users are evaluated by the system in a syntactic, and/or lexical and/or semantic analysis to identify similar of interests as stated by two users, so that those users may potentially be matched for social networking (i.e. with common interests and overlapping geographic areas). Users who have been matched for social networking may view each other's stated interest, to determine whether to a person for further social interaction. The user may change his or her specified interest at any time, to focus or increase the scope of interest and persons suggested for networking.

In particular embodiments, user defines the geographic area of interest by way of a graphical map. The geographic area may, for example, be defined as an ellipse, having a user selected location, shape, and/or orientation. The geographic area can also be defined by any other mathematically/geometrically recognizable shape including a contour hand-drawn by the user, or by using one or more existing geographic boundaries of the map (road, river, coastline, governmental or administrative boundary or the like). The geographic area of interest in one embodiment must include the user's location. The geographic areas of users are compared by the system to identify users having overlapping geographic areas who may potentially be matched for social networking (i.e. the users have common interests and overlapping geographic areas). Users who have been matched for social networking (i.e. with overlapping geographic areas and common interests) may view each other' locations, to determine whether to further socially interact with one or several of the matched users. The user may change his or her defined geographic area at any time, to focus or increase the area and persons suggested for networking.

Upon first engagement with the system, a user may be associated with a default interest and default geographic area upon login, to initially engage the user in social networking with other users. The user can, however, change the default interest and default geographic area to suit preferences.

Social networking interaction between matched users can include message communication, such as Internet messaging or SMS communication, among others.

User interaction with the system may be limited in time to ensure responsiveness and interest of users participating in the system. These time limits may be extended or eliminated for certain users, such as users seeking networking on behalf of a public-accommodating business.

### BRIEF DESCRIPTION OF THE DRAWINGS

The present disclosure will be more readily understood from a detailed description of some example embodiments taken in conjunction with the following figures:

FIG. 1 is a block diagram illustrating a mobile computing device in accordance with one non-limiting embodiment;

FIG. 2 is a block diagram of a LATIN platform implementing LATINs for a plurality of mobile devices;

FIG. 3 is a data flow diagram illustrating the interaction of the mobile devices and platform;

FIGS. 4A and 4B illustrate a mobile device screen presented by a mobile device when a user is (FIG. 4A) and is not (FIG. 4B) part of a LATIN;

FIGS. 5 and 6 are diagrammatic illustrations of the matching process used between LATIN users;

FIGS. 7A, 7B, 8A, 8B and 9A and 9B illustrate the home screen of the LATIN application and manipulation of the map;

FIGS. 10A, 10B, 11A, 11B, 12A and 12B illustrate the modification of a geographic area by a user of the LATIN application;

FIGS. 13A and 13B illustrate a map showing the geolocations of matched users who have been placed in a LATIN with the user of the device;

FIGS. 14A and 14B illustrate various methods for viewing the specific interests expressed by matched users in one or more LATINs;

FIG. 14C illustrates a method for messaging with a matched user having a common interest;

FIG. 15A illustrates the process performed by the LATIN platform of FIG. 2 in identifying users that should be joined in a LATIN; and

FIG. 15B illustrates the process of joining a LATIN performed at a mobile device interacting with the LATIN platform of FIG. 2, including performing a feedback process to refine identified interests and geographic areas, and communicating with matched users in with the LATIN platform of FIG. 2.

### DETAILED DESCRIPTION

Various non-limiting embodiments of the present disclosure will now be described to provide an overall understanding of the principles of the structure, function, and use of the systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The presently disclosed embodiments are generally directed to a platform and method that permits a person with a mobile computing or another located device to identify, contact and interact with other users of similar devices present in the same area that share a common interest and desire to communicate relating to that interest.

The system of the present invention enables Limited Area Temporary Instantaneous Networks, which herein be known as “LATINs”. The system of the present invention will be referred to as the LATIN system. The LATIN platform uses specially developed software which gathers the identification of users, respective users' geo-locations, geographic areas where users wish to enter into contact with one or more matched users, and the present interests for which users wish to connect with matched users sharing the same or similar interests. The LATIN system determines whether LATIN current users are present in the same area and share a common interest. These users are then enrolled in each other's LATIN.

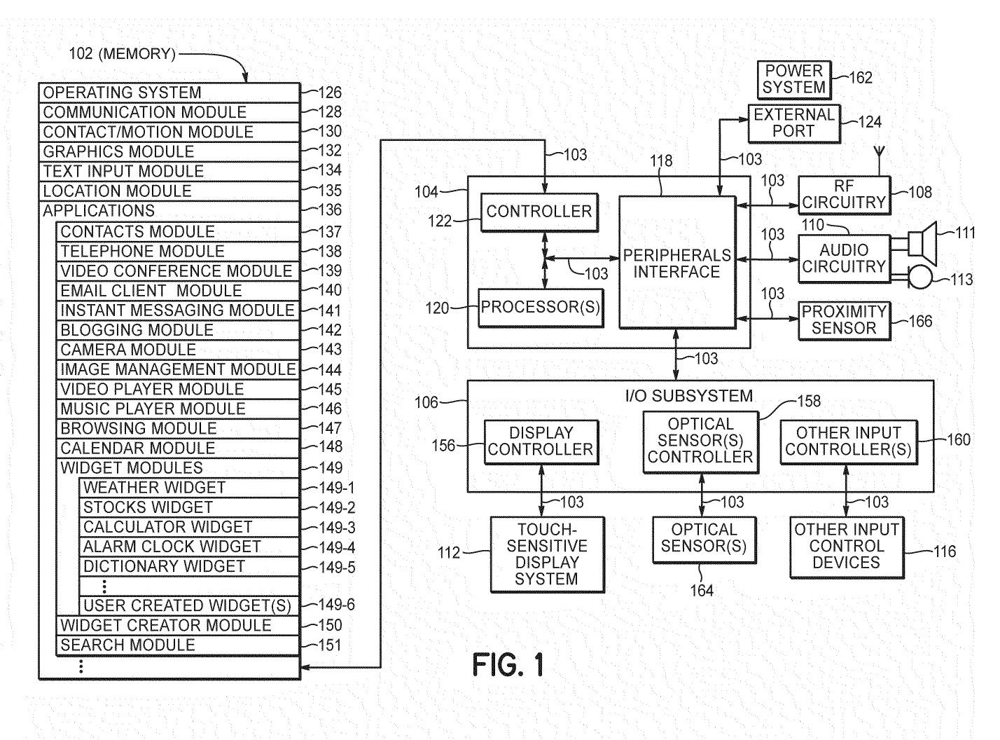

The LATIN platform interacts with mobile or other locatable computing devices having an operating system capable of installing and running applications, and supports network connectivity of those applications. FIG. 1 is a block diagram illustrating a mobile computing device 100 which may be utilized in accordance with the systems and methods described herein. The device 100 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

It will be appreciated that the device 100 is only one example of a mobile or other locatable computing device 100, and that the device 100 may have more or fewer components than shown, may combine two or more components, or a may have a different configuration or arrangement of the components. The various components shown in FIG. 1 may be implemented in hardware, software or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the device 100 and to process data.

In some embodiments, the peripherals interface 118, the CPU 120, and the memory controller 122 may be implemented on a single chip, such as a chip 104. In some other embodiments, they may be implemented on separate chips.

The RF (radio frequency) circuitry 108 receives and sends RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), Long Term Evolution (LTE), time division multiple access (TDMA), Bluetooth, Wireless Fidelity (Wi-Fi) (such as, for example, IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document.

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. In some embodiments, the audio circuitry 110 also includes a headset jack (not shown). The headset jack provides an interface between the audio circuitry 110 and removable audio input/output peripherals, such as output-only headphones or a headset with both output and input.

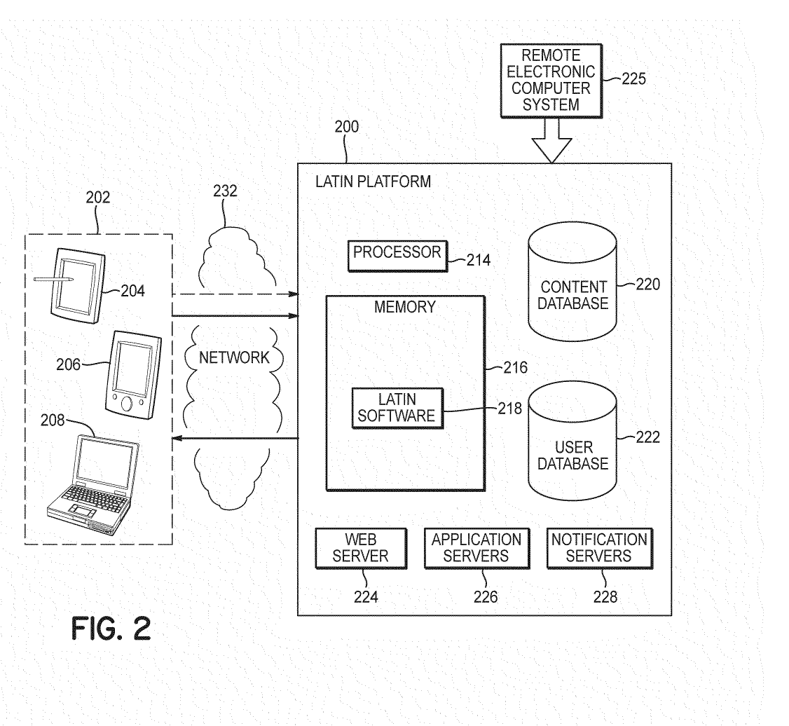

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons, dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (208, FIG. 2, for example) may include an up/down button for volume control of the speaker 111 and/or the microphone 113. The one or more buttons may include a push button (206, FIG. 2, for example). The touch screen 112 is used to implement virtual or soft buttons and one or more soft keyboards.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”). In some embodiments, some or all of the visual output may correspond to user-interface objects, further details of which are described below.

A touch screen 112 has a touch-sensitive surface, sensor or set of sensors that accepts input from the user based on haptic and/or tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects that are displayed on the touch screen. In an exemplary embodiment, a point of contact between a touch screen 112 and the user corresponds to a finger of the user.

The touch screen 112 may use LCD (liquid crystal display) technology, OLED (organic LED), or LPD (light emitting polymer display) technology, although other display technologies may be used in other embodiments. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112. The user may make contact with the touch screen 112 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, the device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 112 or an extension of the touch-sensitive surface formed by the touch screen.

In some embodiments, the device 100 may include a click wheel as an input control device 116. A user may navigate among and interact with one or more graphical objects (henceforth referred to as icons) displayed in the touch screen 112 by rotating the click wheel or by moving a point of contact with the click wheel (such as where the amount of movement of the point of contact is measured by its angular displacement with respect to a center point of the click wheel.) The click wheel may also be used to select one or more of the displayed icons. For example, the user may press down on at least a portion of the click wheel or an associated physical button. User commands and navigation commands provided by the user via the click wheel may be processed by an input controller 160 as well as one or more of the modules and/or sets of instructions in memory 102.

The device 100 also includes a power system 162 for powering the various components. The power system 162 may include a power management system, one or more power sources, a recharging system, a power failure detection circuit, a power converter or inverter, a power status indicator (such as a light-emitting diode (LED)) and any other components associated with the generation, management and distribution of power in portable devices.

The device 100 may also include one or more optical sensors 164. FIG. 1 shows an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 144, the optical sensor 164 may capture still images or video. In some embodiments, an optical sensor is located on the back of the device 100, opposite the touch screen display 112 on the front of the device so that the touch screen display may be used as a viewfinder for either still and/or video image acquisition. In some embodiments, an optical sensor is located on the front of the device so that the user's image may be obtained for videoconferencing while the user views the other video conference participants on the touch screen display. In some embodiments, the position of the optical sensor 164 can be changed by the user (such as by rotating the lens and the sensor in the device housing) so that a single optical sensor 164 may be used along with the touch screen display for both video conferencing and still and/or video image acquisition.

The device 100 may also include one or more proximity sensors 166. FIG. 1 shows a proximity sensor 166 coupled to the peripherals interface 118. Alternately, the proximity sensor 166 may be coupled to an input controller 160 in the I/O subsystem 106. In some embodiments, the proximity sensor turns off and disables the touch screen 112 when the multifunction device is placed near the user's ear. In some embodiments, the proximity sensor keeps the screen off when the device is in the user's pocket, purse, or other dark area to prevent unnecessary battery drainage when the device is a locked state.

The software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (such as a PALM OS, MICROSOFT OS, APPLE OS, UNIX OS, LINUX OS, SYMBIAN OS, EMBEDIX OS, Binary Run-time Environment for Wireless (BREW) OS, JavaOS, a Wireless Application Protocol (WAP) OS, and others) includes various software components and/or drivers for controlling and managing general system tasks (such as memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (such as a Universal Serial Bus (USB), FIREWIRE, etc.) is adapted for coupling directly to other devices or indirectly over a network (such as the Internet, wireless LAN, etc.). In some embodiments, the external port is a multi-pin connector that is the same as, or similar to and/or compatible with the 30-pin connector used on IPOD (trademark of Apple Computer, Inc.) devices.

The contact/motion module 130 may detect contact with the touch screen 112 (in conjunction with the display controller 156) and other touch sensitive devices (such as a touchpad or click wheel). The contact/motion module 130 includes various software components for performing various operations related to detection of contact, such as determining if contact has occurred, determining if there is movement of the contact and tracking the movement across the touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (such as one finger contacts) or to multiple simultaneous contacts (such as “multitouch”/multiple finger contacts). In some embodiments, the contact/motion module 130 and the display controller 156 also detects contact on a touchpad. In some embodiments, the contact/motion module 130 and the controller 160 detects contact on a click wheel.

The graphics module 132 includes various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like. An animation in this context is a display of a sequence of images that gives the appearance of movement, and informs the user of an action that has been performed (such as moving an email message to a folder). In this context, a respective animation that confirms an action by the user of the device typically takes a predefined, finite amount of time, typically between 0.2 and 1.0 seconds, and generally less than two seconds.

The text input module 134, which may be a component of graphics module 132, provides soft keyboards for entering text in various applications, such as contacts 137, e-mail 140, IM 141, blogging 142, browser 147, and any other application that needs text input.

The location module 135 determines the location of the device and provides this information for use in various applications, such as to telephone 138 for use in location-based dialing, to camera 143 and/or blogger 142 as picture/video metadata, and to applications that provide location-based services such as weather widgets, local yellow page widgets, and map/navigation widgets. The location module may utilize GPS satellites for precise geo-location, or other technologies which provide accurate location data. Local conditions, particularly in cities, sometimes impede the reception of the GPS signals. This problem can be at least partly overcome by “assisted GPS” or “synthetic GPS” with some assistance of WiFi, cellular networks, sensors (accelerometer, pressure meters . . . ) or advanced positioning algorithm in the device. GPS and other location services are present on virtually all smartphones and most tablets. The continuous positioning data are particularly useful for mobile devices continuously connected to the Internet i.e. through the cellular network.

The applications 136 may include the following modules (or sets of instructions), or a subset or superset thereof: a contacts module 137 (sometimes called an address book or contact list); a telephone module 138; a video conferencing module 139; an e-mail client module 140; an instant messaging (IM) module 141; a blogging module 142; a camera module 143 for still and/or video images; an image management module 144; a video player module 145; a music player module 146; a browser module 147; a calendar module 148; widget modules 149, which may include weather widget 149-1, stocks widget 149-2, calculator widget 149-3, alarm clock widget 149-4, dictionary widget 149-5, and other widgets obtained by the user, as well as user-created widgets 149-6; widget creator module 150 for making user-created widgets 149-6; and/or search module 151.

Examples of other applications 136 that may be stored in memory 102 include memo pad and other word processing applications, JAVA-enabled applications, encryption, digital rights management, voice recognition, and voice replication.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory 102 may store a subset of the modules and data structures identified above. Furthermore, memory 102 may store additional modules and data structures not described above.

Referring now to FIG. 2, the LATIN platform 200 may be provided using any suitable processor-based device or system, such as a personal computer, laptop, mainframe, or a collection (e.g., network) of multiple computers, for example. Platform 200 may include one or more processors 214 and one or more computer memory units 216. For convenience, only one processor 214 and only one memory unit 216 are shown in FIG. 2. The processor 214 may execute software instructions stored on the memory unit 216. The processor 214 may be implemented as an integrated circuit (IC) having one or multiple cores. The memory unit 216 may include volatile and/or non-volatile memory units. Volatile memory units may include random access memory (RAM), for example. Non-volatile memory units may include read only memory (ROM), for example, as well as mechanical non-volatile memory systems, such as, for example, a hard disk drive, an optical disk drive, etc. The RAM and/or ROM memory units may be implemented as discrete memory ICs, for example.

The memory unit 216 may store executable software and data for the platform, including the software implementing the LATIN service 218. When the processor 214 of the platform 200 executes the software of the LATIN service 218, the processor 214 may be caused to perform the various operations of the platform 200. Operations may include, without limitation, receiving a location of a mobile computing device 202, identifying interests of the user of the device 202, providing maps and information to the device 202, comparing the location and interests of multiple devices, and sending contact information for matched users and messages between users to mobile computing devices 202 via a wireless communication network. Data used by the device 202 may be from various sources, such as a content database 220, which may be an electronic computer database of maps, interest descriptions, and the like, for example. The data stored in the content database 220 may be stored in a non-volatile computer memory, such as a hard disk drive, a read only memory (e.g., a ROM IC), or other types of non-volatile memory. Also, the data of the content database 220 may be stored on a remote electronic computer system, for example.

User database 222, which may be an electronic computer database, for example, stores information about users connected to the LATIN platform 200. The data stored in the user database 222 may be stored in a non-volatile computer memory, such as a hard disk drive, a read only memory (e.g., a ROM IC), or other types of non-volatile memory. Data stored in the user database 222 may include location and interest information regarding particular users of the system 200, as well as user preferences and so forth.

Data of the user database content database 220 or user database 222 may be stored on a remote electronic computer system such as 224.

The system 200 may be in communication with mobile computing devices 202 via an electronic communications network 232. The communications network may include a number of computer and/or data networks, including the Internet, LANs, WANs, GPRS networks, etc., and may comprise wired and/or wireless communication links. The mobile computing devices 202 that communicate with the LATIN platform 200 may be any type of client device suitable for communication over the network, such as a smart phone, tablet, netbook, laptop or other portable personal computer, for example. It can be appreciated that while certain embodiments may be described with users communication via a smart phone, the communication may be implemented using other types of equipment or wireless computing devices such as a mobile telephone, personal digital assistant (PDA), combination mobile telephone/PDA, handheld device, mobile unit, game device, messaging device, media player, or other suitable mobile communications devices.

By way of illustration, FIG. 2 shows example mobile computing devices 202, including a tablet computer 204, a smart phone 206, and a netbook 208. Other types of mobile computing devices may be used.

Some of the mobile computing devices 202 also may support wireless wide area network (WWAN) data communications services including Internet access. Examples of WWAN data communications services may include Evolution-Data Optimized or Evolution-Data only (EV-DO), Long Term Evolution (LTE), Evolution For Data and Voice (EV-DV), CDMA/1xRTT, GSM with General Packet Radio Service systems (GSM/GPRS), Enhanced Data Rates for Global Evolution (EDGE), High Speed Downlink Packet Access (HSDPA), High Speed Uplink Packet Access (HSUPA), and others. The user device 102 may provide wireless local area network (WLAN) data communications functionality in accordance with the Institute of Electrical and Electronics Engineers (IEEE) 802.xx series of protocols, such as the IEEE 802.11a/b/g/n series of standard protocols and variants (also referred to as “Wi-Fi”), the IEEE 802.16 series of standard protocols and variants (also referred to as “WiMAX”), the IEEE 802.20 series of standard protocols and variants, and others.

In some example embodiments, the mobile computing devices 202 also may be arranged to perform data communications functionality in accordance with shorter range wireless networks, such as a wireless personal area network (PAN) offering Bluetooth® data communications services in accordance with the Bluetooth®. Special Interest Group (SIG) series of protocols, specifications, profiles, and so forth. Other examples of shorter range wireless networks may employ infrared (IR) techniques or near-field communication techniques and protocols, such as electromagnetic induction (EMI) techniques including passive or active radio-frequency identification (RFID) protocols and devices.

Similar to the mobile computing device 100 illustrated in FIG. 1, a mobile computing device 202 may provide a variety of applications for allowing a user to accomplish one or more specific tasks using the LATIN platform 200. The mobile computing device 202 may comprise various software programs such as system programs and applications to provide computing capabilities in accordance with the described embodiments. System programs may include, without limitation, an operating system (OS), device drivers, programming tools, utility programs, software libraries, application programming interfaces (APIs), and so forth. As is to be appreciated, the mobile computing device 202 may include any suitable OS, such as a mobile OS (ANDROID, BLACKBERRY OS, iOS, SYMBIAN OS, WINDOWS PHONE, and so forth), a desktop OS (MAC OS X, LINUX, WINDOWS, GOOGLE CHROME OS, and so forth) or a television OS (GOOGLE TV, APPLE TV, or other Smart TV OS), for example.

In general, a software application may provide an interface to communicate information between the platform 200 and the user via mobile computing devices 202. The software application may include or be implemented as executable computer program instructions stored on computer-readable storage media such as volatile or non-volatile memory capable of being retrieved and executed by a processor to provide operations for the mobile computing device 202. The memory may also store various databases and/or other types of data structures (e.g., arrays, files, tables, records) for storing data for use by the processor and/or other elements of the user devices 202.

Referring still to FIG. 2, the LATIN platform 200 may include several computer servers. For example, the LATIN platform 200 may include one or more web servers 224, application servers 226, and notification servers 228. For convenience, only one web server 224, application server 226, and one notification server 228 are shown in FIG. 2, although it should be recognized that this disclosure is not so limited. The web server 224 may provide a graphical web user interface through which users of the system (such as content owners or managers) may interact with the LATIN platform 200 on a browser interface. The web server 224 may accept requests, such as HTTP requests, from clients (such as web browsers) such as HTTP responses, along with optional data content, such as web pages (e.g., HTML documents) and linked objects (such as images, etc.).

The application server 226 may provide a user interface for users communicating with the LATIN platform 200 via specialized client applications such as mobile device apps. Such users may have software installed on their mobile computing device 202 that allows them to communicate with the application server 226 via the network 232. Such software may be downloaded, for example, from the LATIN platform 200, or other software application provider, over the network to such user mobile computing device 202. The software may also be installed on such mobile computing device 202 by other means known in the art.

The notification server 228 may cause notifications, such as emails, text messages, smart phone notifications, phone calls, or other types of communications, to be sent to the mobile computing device 202 via the network 232 and to track/store the notifications.

The servers 224, 226, 228 may comprise processors (such as CPUs, for example), memory units (such as RAM, ROM, for example), non-volatile storage systems (such as hard disk drive systems, for example). The servers 224, 226, 228 may utilize operating systems, such as Solaris, Linux, or Windows Server operating systems, for example.

Although FIG. 2 depicts a limited number of elements for purposes of illustration, it can be appreciated that the LATIN platform 200 may include more or fewer elements as well as other types of elements in accordance with the described embodiments. Elements of the LATIN platform 200 may include physical or logical entities for communicating information implemented as hardware components (computing devices, processors, logic devices, and so forth), executable computer program instructions (firmware, software) to be executed by various hardware components, or combination thereof, as desired for a given set of design parameters or performance constraints.

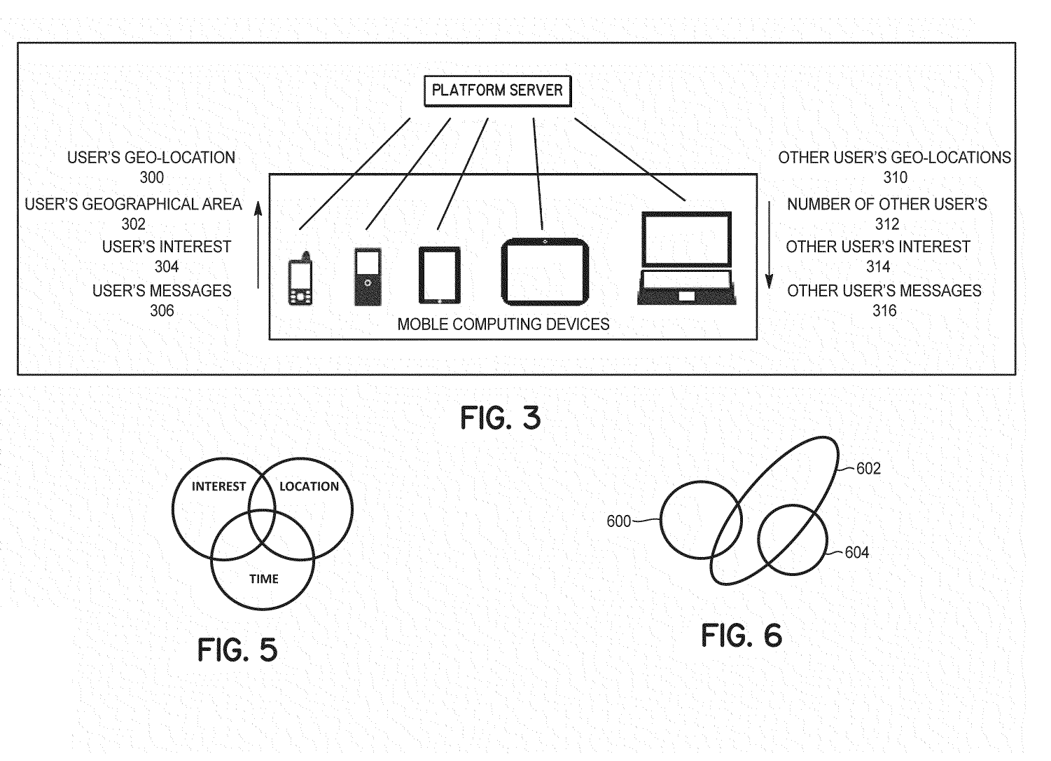

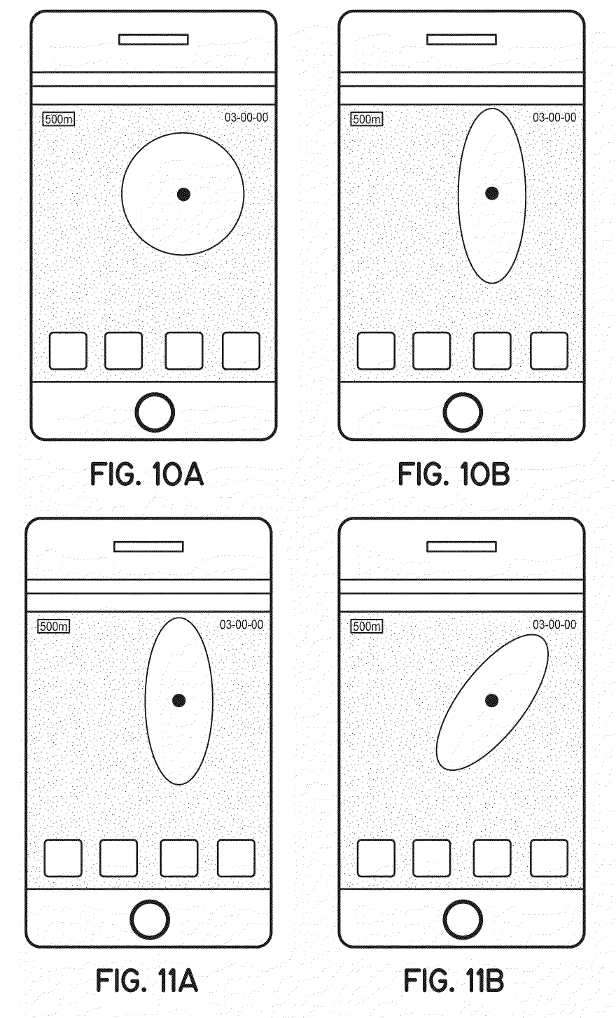

Interaction of mobile devices of FIG. 1 and the platform of FIG. 2 can now be detailed with reference to FIG. 3. Mobile computing devices (and/or other locatable devices which are controlled by users communicate to platform 200 running the dedicated software. Each device delivers to the platform the device's geo-location 300, the device user's geographic area 302 (see FIGS. 10A, 10B, 11A and 11B), and the device user's interest 304 as to which the user wishes to enter into contact with matched users sharing the same or a similar interest. Each device may present multiple geographic areas and multiple interests to the platform server for matching to multiple potential LATINs.

The platform 200 determines which users are currently present in the same area (defined as intersecting (i.e., overlapping) geographic areas” as discussed below) and share a common interest. These users are then assigned to each other's LATINs. The platform 200 communicates to each user information on Matched users in his LATIN, including their number 312 and their respective geo-location 310 and interest 314.

Users in each other's LATIN can then exchange instant messages 306 and 316 with one another through the platform 200.

The use of the LATIN platform 200 with a mobile or other located device is now outlined. To use LATIN with a mobile device, the user must first download the LATIN App, register with the LATIN platform 200 and log into the LATIN Application.

The LATIN Application can be downloaded like any other application for smartphones. The user searches for a “Latin” application in one of the “stores” or “market places”, e.g., the App Store (Apple), Play (Google), R.I.M. or App Word (Blackberry), Windows Phone Market Place (Microsoft) and many others. The LATIN Application is then selected and the user follows the downloading instructions.

The user of a smartphone or of any other computing device connected to the Internet can also access the LATIN webserver with a device browser, and then follow downloading instructions.

After the LATIN App has been downloaded, the user must register with the platform 200 before being able to use the LATIN System.

The information collected by the platform 200 for each user includes:

Information for registration

| | |
|---|---|
| User's name | Optional |
| Login | Yes |
| Email address | Yes |
| Password | Yes |
| device phone number | Optional |
| device IP | Yes |
| Geolocation current | Yes |
| Debit or credit Card/bank account | Optional |
| references | |

Registration further requires acceptance of Terms and Conditions which authorize the System to collect and record the user's geo-location, interest and messages exchanged within a LATIN.

After registration, the user may run the LATIN Application downloaded in the device. The user will then input the login and password registered, which the platform 200 instantaneously verifies. When authenticated, the LATIN Application launches a user into a session with the platform 200.

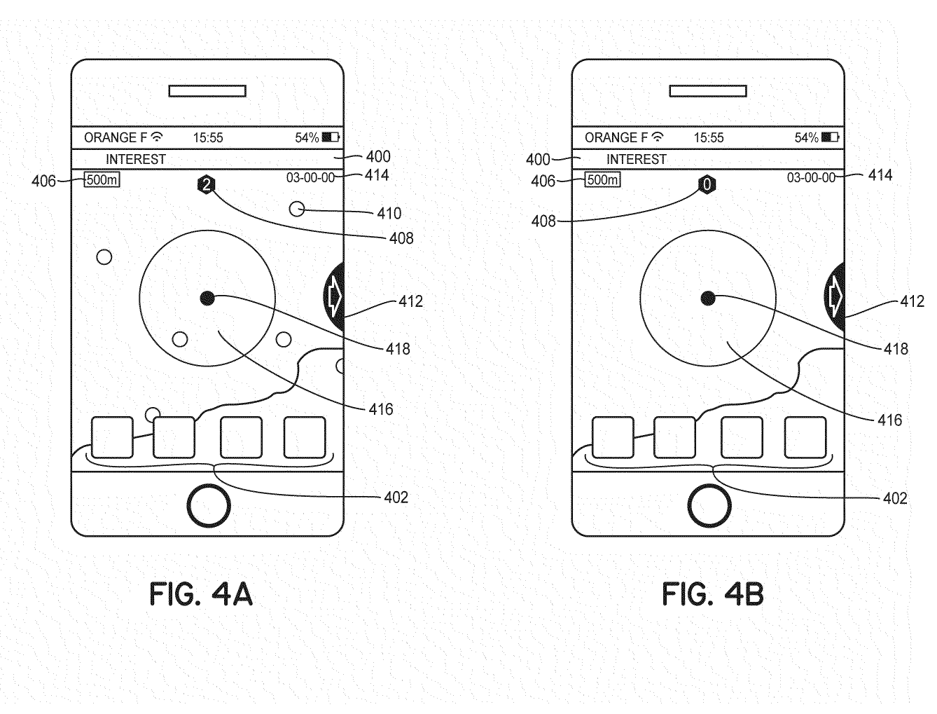

FIGS. 4A and 4B illustrate a main screen of the LATIN Application. FIG. 4A is the display generated when the user is part of an active LATIN, and FIG. 4B illustrates the display when the user is not part of an active LATIN. Each screen displays the following information:

| Interest 400 | The interests as to which a connection is sought are displayed in |
|---|---|
| | the rectangular box displayed on the device's screen. |
| LATIN icons 402 | The icons displayed on the device to invoke functions of the LATIN |
| | Application. More are accessible by “scrolling” the icons sideways. |
| | The icons could include, for example, “set-up”, “stand-by” and “log- |
| | out” LATIN icons. The number and placement of the icons is |
| | entirely discretionary and may be adjusted by the user as a |
| | preference/setting of the Application. |
| Map 404 | The map displayed on the screen in the illustrated embodiment is |
| | relatively large and covers the whole screen except the opaque |
| | interest box and the semitransparent LATIN icons. The default Map |
| | is displayed in FIGs. 4A and 4B, so that the user's geo-location is its |
| | center. |
| Map scale 406 | The scale of the map, in meters or other usual length units. |
| Number of “outside” | Number of matched users who are part of the user's LATIN, but are |
| Matched Users 408 | not located inside the Map. |
| Matched Users 410 | Matched users who are part of the user's LATIN and are located |
| | inside the Map displayed on the screen. |
| Tab 412 | The tab used to go to the “interest list”. |
| Time left 414 | Time left under a Session, which is reset to a default duration each |
| | time the Application is used. |
| User's Geographic | The area freely demarcated by the user, within which other users |
| Area 416 | are desired to be engaged for a connection, and which necessarily |
| | includes the user's location. The default GA is a circle whose radius |
| | can be changed in the Application Set-up. |
| User's geo-location | The user's geo-location on the Map. |
| 418 | |

The use of these features will now be explained. After logging into the system, each user defines his own geographic area (including his or her location) and interest. The user's device sends this continuously updated information to the platform. The platform compares the elements received from the different users and creates a LATIN between users fulfilling two conditions:
they are present in intersecting geographic areas (“GAs”), and
they have expressed a matching interest.

These conditions are tested for all other current users, i.e., users that are logged in to the platform. Thus, for users to be matched they necessarily are using the application within the same time frame and share time overlapping sessions.

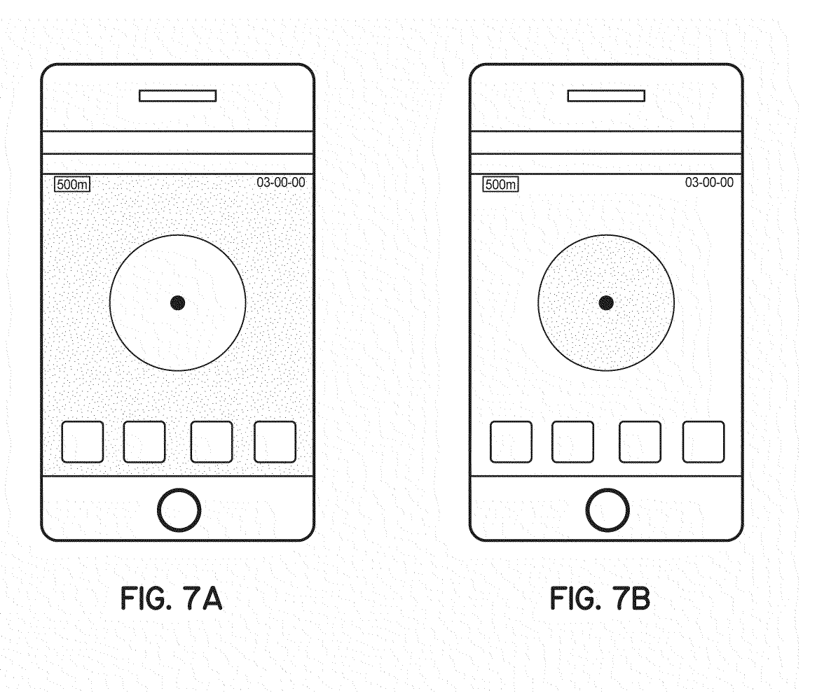

As illustrated generally in FIG. 5, The platform searches for current users with intersecting geographic areas and with common interests; the criteria for matching two current users are thus Location and interest, all current users are also necessarily interacting with the platform during the same time frame. These users are then brought into LATINs with each other. The specifics of these two criteria will now be discussed.

The first condition for users to be able to connect is to share a somewhat common location. For the LATIN System to determine if two users share a somewhat common location:

Each device identifies its user's geo-location and each user freely defines the geographic area around his or her geo-location where or for which he/she is interested to come into contact with matched users (in his/her geographic area or “GA”).

The platform 200 compares the users' geographic areas and allows users with current intersecting geographic areas to connect, provided that they also share a common interest.

Referring now to FIG. 6, in one example, three users have defined geographic areas 600, 602 and 604, respectively. In this example, the two geographic areas are defined as circles and one as an ellipse. GAs 600 and 602 intersect, GAs 602 and 604 intersect, but GAs 600 and 604 don't intersect. In this situation, the users with GAs 600 and 604 cannot be part of each other's LATIN.

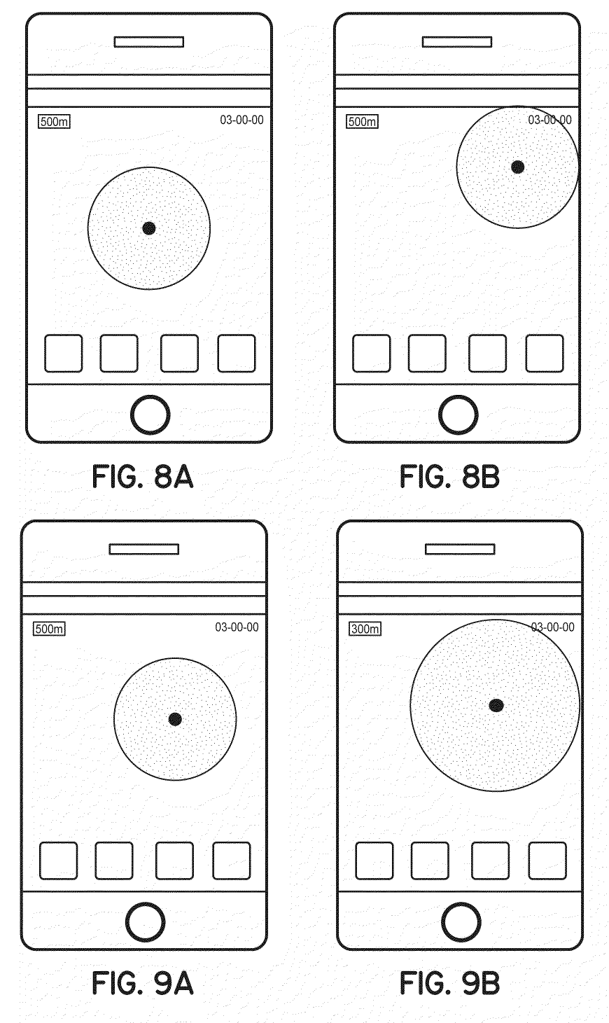

As noted above, when a user opens the Application on his device, the device screen displays a default Map and a default geographic area. Referring now to FIG. 7A, the default geographic area is shown as a highlighted (which refers to any form of color, intensity or shading change that is visually distinct) disk (not stippled and therefore ‘brighter’ in FIG. 7A) inside the Map. Initially, the default GA is centered on the user's location which is indicated by a colored dot, whose position is given by the positioning function of the device and which is displayed in the center of the screen of the device. From this initial state, the user may either (1) differently visualize his current geographic area within the Map, i.e. modify the Map, by modifying the whole displayed Map, or (2) change the size or the shape of the geographic area.

To modify the whole Map or the GA within the Map, the user must first select either the part of the Map outside the geographic area or the geographic area. If the GA is highlighted (visually distinguished) as seen in FIG. 7A (the default case when a user starts the Application), the user makes a standard multi-touch gesture (e.g. a “double tap”) on a part of the Map which is not highlighted, i.e. outside the GA. The Map outside the GA becomes highlighted (visually distinguished) as seen in FIG. 7B (not stippled in FIG. 7B) and the GA becomes unhighlighted (e.g. less distinct e.g. less clear and contrasted). The user can then modify the Map.

The user can return to a highlighted GA, by using the same standard multi-touch gesture (e.g. a “double tap”) inside the GA. He can then modify the GA within the Map.

The user can either move the Map or change the Map scale when the map is selected, by scrolling or zooming in or out, as illustrated in FIGS. 8A, 8B, 9A and 9B.

To decenter the user's geo-location, the user moves the displayed Map, by using a standard touch-screen gesture (e.g. a “scroll”) on a smartphone or a tablet, or other accurate means according to the device technology. As seen by comparing FIG. 8A to FIG. 8B, the user's geo-location (central dot in the GA) and the GA remain at the same place on the map, but move with the Map. In effect, moving the Map decenters the user's geo-location, but the GA and map scale remains unchanged.

The user can also change the Map scale, by using standard touch-screen gestures, e.g.: “spread” for zooming in (from the left to the right drawing), “pinch” for zooming out (from the right to the left drawing) while the Map is selected. Doing so, as seen by comparing FIG. 9A to FIG. 9B, the indicated scale changes, and although the geo-location remains unchanged it typically is slightly displaced on the screen as a result of the typical offset created when performing a zoom in or zoom out gesture. The screen area displaying the geographic area is enlarged after a zoom in, and reduced after a zoom out.

The Application may automatically limit Map moves or changes of Map scale, e.g., by requiring that the geographic area is always entirely displayed on the screen, and/or that the user's location always remains on the screen. Note, by definition, in this embodiment the user's location must also always be within the user's geographic area.

For each new Session, a user may define a geographic area to fit Session-specific preferences, or narrows or enlarges the search area for matched users, depending on the user's location and interest and the number, locations and interests of matched users belonging to a current LATIN. In certain embodiments the user can define the geographic area by transforming the circular default geographic area into an ellipse or by using any other mathematically/geometrically recognizable shape including a contour hand-drawn by the user, or by using one or more existing geographic boundaries of the map (road, river, coastline, governmental or administrative boundary or the like).

The starting or default GA is a disk centered on the user's location displayed in the center of the screen of the device and generated by the Application when the user logs into the System, as seen in FIGS. 4A and 4B, for example. The GA radius is set by default by the application, but can be adjusted in the set-up menu within the following limits: the default GA must be large enough to allow the standard touch-screen gestures to be applied to it, and the default GA must be entirely seen on the screen.

When the geographic area is highlighted as seen in FIG. 10A, the user can modify the geographic area, specifically, modify the size and the shape of the geographic area.

In the disclosed embodiment, the Application defines a geographic area as an ellipse, which is a more versatile shape than a simple circle, but which may be a circle (as is the case with the default GA) which is an ellipse whose two foci are gathered in the center. An ellipse is mathematically defined by a small amount of data (center, distance between its two foci, its major and minor semi axes) which is readily transmits between devices and the platform 200.

The ellipse (including the circle of the default GA), or another mathematically recognizable shape, can be modified by standard touch-screen gestures when the GA is highlighted, i.e., “spread” in the GA, for enlarging the GA, and “pinch” in the GA , for reducing the GA (compare FIG. 10A to FIG. 10B for the results of a horizontal “pinch”). During these movements, the displayed Map including its scale is otherwise unchanged, and the user's position remains at the center of the ellipse axes.

Depending on where the user precisely applies his or her fingers in the ellipse, the gesture will lengthen or shorten one of the minor axis or major axis of the ellipse. The axes of the ellipse (or other symmetrical shape) are initially parallel to the sides of the screen as seen in FIGS. 10B and 11A, however, the shape can be rotated as seen in FIG. 11B. Specifically, the user can change the orientation of the geographic area by using the standard touch screen gesture on the highlighted GA (for instance the “rotate” gesture); the axes of the ellipse (or other symmetrical shape) remain perpendicular to each other but are no longer parallel to the sides of the screen. The user position, however, remains at the center of the GA, but the GA is rotated around the user's location as seen by comparison of FIG. 11A to FIG. 11B.

In certain embodiments the user can define the geographic area by hand-drawing its contour, or by using one or more existing geographic boundaries of the map (road, river, coastline, governmental or administrative boundary or the like).

The user can also move the whole GA, whatever its shape, around the user's location, by using the standard touch-screen gesture “scroll” within the GA. As seen in FIG. 12A, the GA keeps is shape and size, but moves relative to the user's location. The Application may limit such moves by the requirement that the user's geo-location always be within the GA. Notably, the background map and the user's position on that map do not move or change scale.

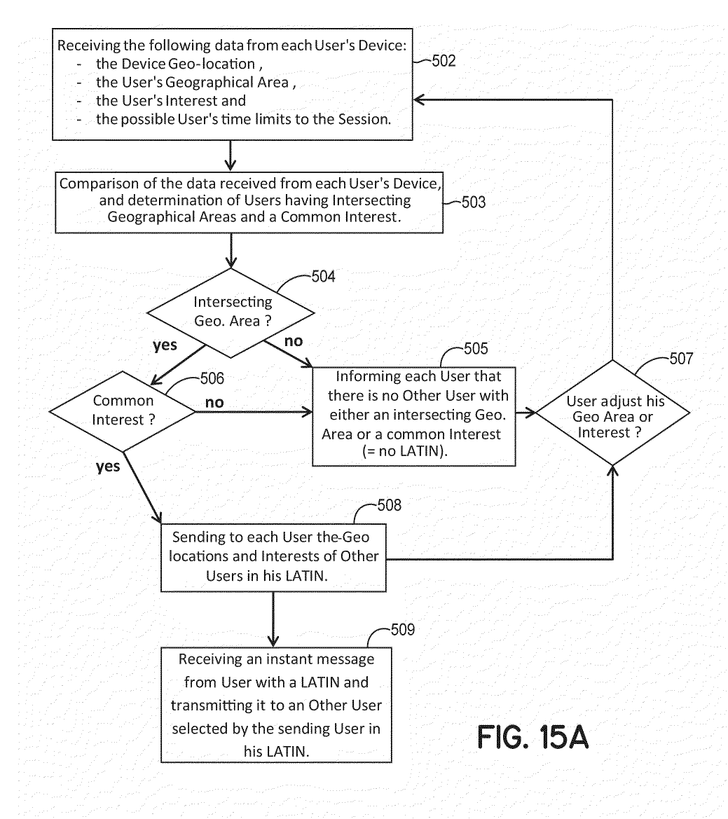

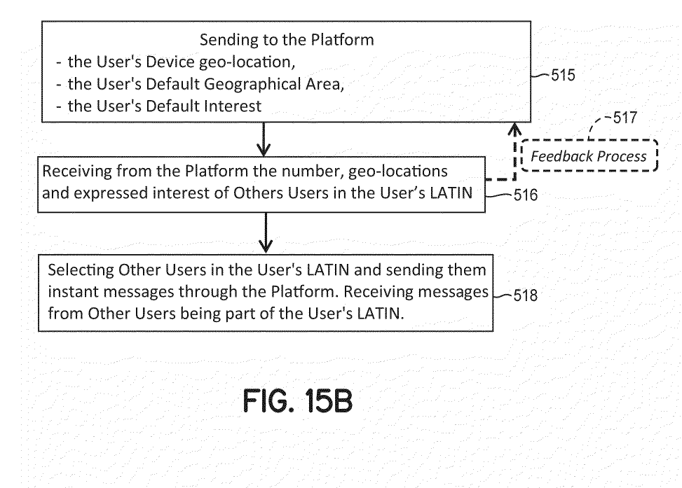

As noted above, and referring now to FIG. 15A, the user's device continuously communicates (step 502) the user's location and chosen geographic area, and interest to the platform 200, to enable comparison thereof (step 503). The platform 200 then determines whether there are users with intersecting GAs (step 504). If there are users are in intersecting GAs, to form a LATIN, two conditions must be fulfilled:

a) Continuous communication of the user's geo-location and geographic area to the platform 200. To test this condition, every few seconds if the location has changed, the Application automatically instructs the device to send the user's geo-location and GA to the platform 200. (The geo-location is provided to the Application by the device using GPS positioning, cellular telephone triangulation or another positioning technique.) Note, the geographic area is freely demarcated by the user as explained above. It can be modified at any time by the user.

b) Continuous comparison of the users' geographic areas by the platform 200. The calculation as to whether different users' GAs intersect is done continuously. For example, referring to the example of FIG. 6, three user GA's (602, 604 and 600) have each defined their respective geographic area represented by an ellipse. As noted above, the users of GAs 600 and 602 can be part of a LATIN as can the users of GAs 602 and 604, but GAs 600 and 604 do not intersect and their users cannot be part of each other's LATIN.

If either of these conditions is not met, then in step 505 the user is informed that no matched user can be found with an intersecting GA or common interest, meaning that the user is not part of a LATIN. Thereafter, in step 507 the user may adjust his or her GA or interest to continue to seek matched users.

Notes: 1) Two users can have intersecting GAs and be part of a LATIN without either user being located in the other user's GA. 2) There is a symmetry between any two users: if user 1 is inside user 2's GA, user 2 is necessarily in user 1's GA.

The second condition to place users in a LATIN, is a common interest. As seen at step 506, in the event two users have an overlapping GA, then the platform 200 tests for a common interest. For the LATIN System to determine if two users share a somewhat common interest, each user expresses an interest for which he wishes to contact matched users, and the platform 200 compares and matches the expressed users' interests, and enables users with matching interests to connect, provided that they also have intersecting geographic areas as noted above.

A matching interest occurs when interests expressed by more than one user in intersecting GAs can be matched to each other by the platform 200 using the method described herein. An “interest” can be any field of information or proposed activity. Since the users' locations are relevant to finding a matching interest, users should use their surroundings to identify interests conducive to the formation of a LATIN in the current area. For example, interest in an activity identified with a given area (e.g. “playing tennis”) may be more likely to identify common interests, than interest in information which is not necessarily linked to a location (e.g. interest in “Roland Garros tennis tournament winners”).

The interest is displayed in the yellow “interest box” 400 (see FIGS. 4A and 4B) in the upper part of the user's device screen. Upon login, a default interest is initially associated with the user, and used as the user's assumed interest when the user logs into the System. The default interest encompasses all possible interests; it is the broadest possible interest. The fact that the current interest is the default interest is indicated by the word “Interest” as seen in FIG. 4A.

The interest may be altered by conventional text editing methods; specifically, the word “Interest” in box 400 can be preceded by a blinking typing cursor (or caret) “|” prompting the user to input his more precisely defined interest. A user can express a new interest or modify the current interest at any time during a Session. To express a current interest, the user makes a standard touch-screen gesture, for instance a “double tap”, on the yellow interest box 400. The key board of the device appears and the user expresses the interest by inputting words in a chosen language (French, English . . . ), e.g. by typing them or speaking them through the voice recognition software (iPhone Siri, Android Assistant) of the mobile device.

The inputted words are displayed on the mobile device screen at the top of the screen in the yellow interest box 400 where the default interest was initially displayed.

The number of characters available to define an interest will be limited to a few tens, for instance 50 characters, including spaces. Note, however, an interest may be later completed by exchange of Messages (see below).

The platform 200 may interact with the user to check the spelling of each word or group of words in the interest and, if appropriate, propose corrections to the user, with an existing orthographic/spelling corrector, for instance to change “tenis” to “tennis”; alternatively, this may be done after attempting to match users.

Any expressed interest is necessarily narrower than the default interest. An example of a narrow interest could be, on a late afternoon, a search for a non-hotel accommodation for 2 persons for the following night in the geographic area.

As shown in FIG. 15A, step 506, the platform 200 compares in real time the interests expressed by all users in intersecting geographic areas, and, if relevant, matches them, and sends each user the GA and interest of matched users (step 508), so that thereafter the platform 200 may receive and forward instant messages from users and forward them to other users in the LATIN (step 509).

As seen in FIG. 15B, to facilitate the processes for matching performed by the platform 200, as soon as launched (step 515), the Application sends the default interest to the platform, and potentially receives in response the number, GAs and expressed interests of matched users in the user's LATIN, if any. When the user inputs or modifies his interest as part of the described feedback process (step 517), the Application automatically sends the newly expressed interest to the platform. This may be done automatically whenever the user, after initially typing an interest expression, stops typing or otherwise inputting his interest for more than, for instance, 3 seconds.

As noted above, interests expressed by more than one user of the System are compared and matched, allowing a common interest to be recognized as such by the platform. The comparison of interests by the platform 200 to identify a common interest is limited to (1) the interests expressed by users (2) in intersecting geographic areas. Consequently, the matching task of the platform can be much simpler than, for instance, searching the web with classical search engines like Google.

The platform 200 uses its own search method of comparing the words or the group of words used to express same or similar interests.

Different sets of words can be used to express identical or similar interests in one language; for a linguist they belong to the same “lexical field” . Example: A user types the following interest: “place to sleep tonight required”. Other users with intersecting GAs have typed their following respective interests: “room to let”, “hotel”, “bed and breakfast”. Different interests (and lexical fields) can also overlap one another. The same word can also belong to several lexical fields.

The platform 200 will use a search engine able to relate different set of words belonging to the same lexical field so that links can be established between users sharing similar interests that they have differently expressed. In a given language, the comparison and matching method (or “search engine”) of the platform consists in syntactic, lexical and semantic analysis, performed by using its own combination of algorithms comparing the interests considered as strings of characters and as words or sequences of words composing these strings and by using external resources (electronic dictionaries, thesauri, morphological databases, stopword databases . . . ). Cross language techniques may also be used. The platform thus conducts any one of or any combination of syntactic, lexical and semantic analysis to match interests, as follows: 1) Syntactic analysis is performed by applying algorithms to the expressed interests considered as strings of characters or applying them to entities composing such strings. 2) Lexical (or language based) analysis adds external linguistic resources (dictionaries, thesauri, morphological databases, stopword databases, . . . ) to apply algorithms to the interests expressed in natural language, where the interests are considered as made of words and/or sequences of words grammatically ordered. 3) Semantic analysis completes the other techniques by emphasizing in matching interests based on their meanings or the meanings of words or sequences of words used in the interest, which may overlap to some extent with lexical analysis.

The user, who can change his or her expressed interest at any time during a Session, will often change it after consulting other users' current matching interests and geo-locations. This feed-back process is an important feature of the System.

User sessions are limited in time. Specifically, when a user logs into the LATIN platform, the duration of the user's Session is limited by a default duration; furthermore, a user can specify a session time limit, although, in this case, the platform may intervene and limit the connection time of the user into a LATIN.

User sessions are temporary to preserve resources. Open-ended user sessions (i.e., extending after the user's actual interest ends) would uselessly consume platform resources in continuously seeking intersecting GAs and matching interests, and also lead matched users into fruitless attempts to participate in a LATIN with a user who is not interested. Accordingly, a Session automatically expires after a Default Period of, for instance, 3 hours; however, the Default Period (re)starts from the last user's interaction with the System: modification of the shape or size of his or her GA, or of his or her interest or sending a message to matched users.

The Default Duration is set by the System, applicable to all users and will be revised from time to time to best adapt to the observed users' behavior. The remaining time under the current Default Period is displayed on the screen of the device at 414 (FIGS. 4A and 4B), with a sound and/or visual alarm attracting the user's attention a short time (e.g. 2 minute) before its expiry. A user can choose to limit in the session duration in advance, to a duration shorter than the Default Duration. This is particularly appropriate when the user has a real but very short term interest. The user can also stop a Session at any time, by using an icon 402 at the bottom of the screen.

The LATIN app supports a stand-by mode. The stand-by mode is entered when a user is still logged in the System, but the LATIN application is backgrounded so that the screen no longer displays the LATIN Application. In the stand-by mode the device is “on”, but not being actively used, or is being used by another application. The user can also activate the stand-by mode for a current Session by a “single tap” on a LATIN stand-by icon appearing, for instance, at the bottom of the screen, at any time during a Session. The device then returns in its opening/main screen on which typically appears the main icon for launching the LATIN Application.

If the user taps on the LATIN icon while there are LATIN Sessions in stand-by mode, the Application will present a screen offering the choice to open a new LATIN Session or to return to any of the Sessions currently in stand-by mode.

With the stand-by mode, the LATIN Application and platform allow one user to be part of several LATINs at the same time, as long as his or her expressed interests are different (e.g. “tennis partner level 3.5 tomorrow” and “does a neighbor has any lemons?”); it does not matter if the geographic areas for each interest are the same one or are all different. The user can place one session in standby mode while participating in another with the LATIN App.

In some embodiments, the System may limit the simultaneous participations of one user to a number, e.g., 5 different LATINs, to avoid possible abuses to matched users, and to prevent an overload of the communication between the platform and the device.

These limits, however, may not be applied to all users. Many businesses (craftsmen, hospitality . . . ) have fixed locations, and fixed location devices. Such users may desire to register lasting or recurrent interests (e.g. their opening days of a shop or “happy” hours of a bar), and forego logging in for limited Sessions. To respond to this need, the platform offers to Business Users or other users that qualify, the optional of logging in automatically—provided their device is connected to Internet—and registering for a Session lasting longer than the usual Default Period, and/or for recurrent Sessions. This special service can be associated with a small fee, appropriate for a commercial venture which would typically be interested in the service. A user wishing to take advantage of this service could be required to provide more verifiable information on their identity, location and nature of their business for security reasons.

Upon the satisfaction of the conditions described above, as noted in FIG. 15B, step 516, a user may be enrolled in a LATIN, and informed by the platform of the number, geo-locations and the expressed interests of the matched users belonging to the user's LATIN.

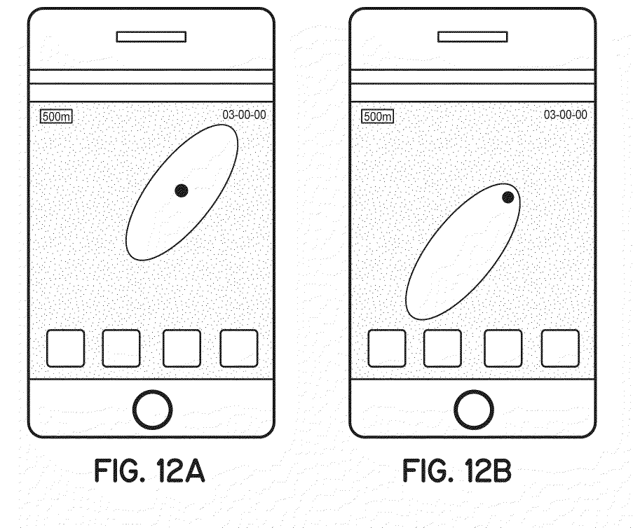

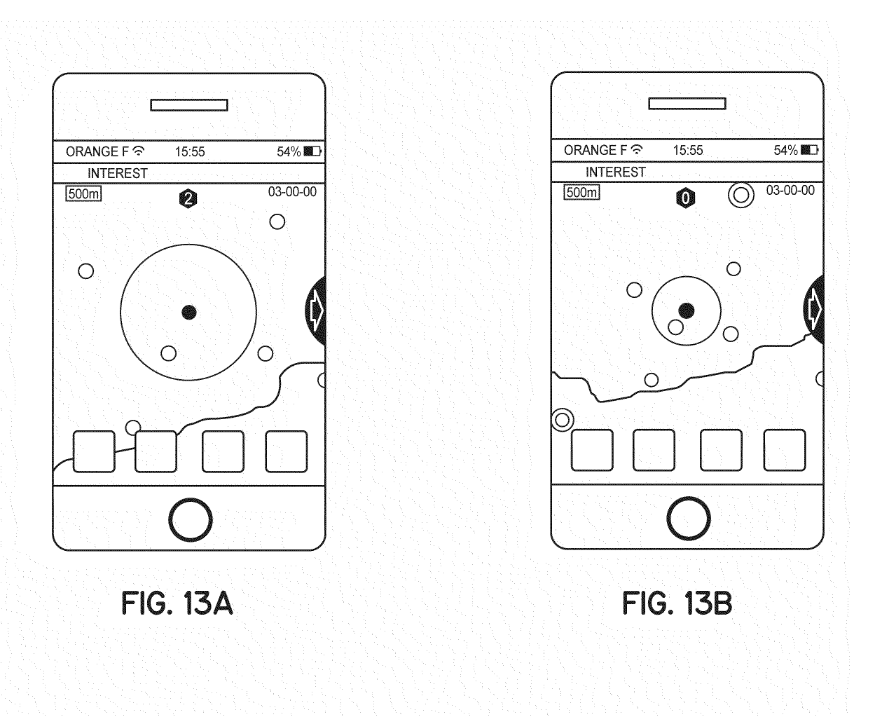

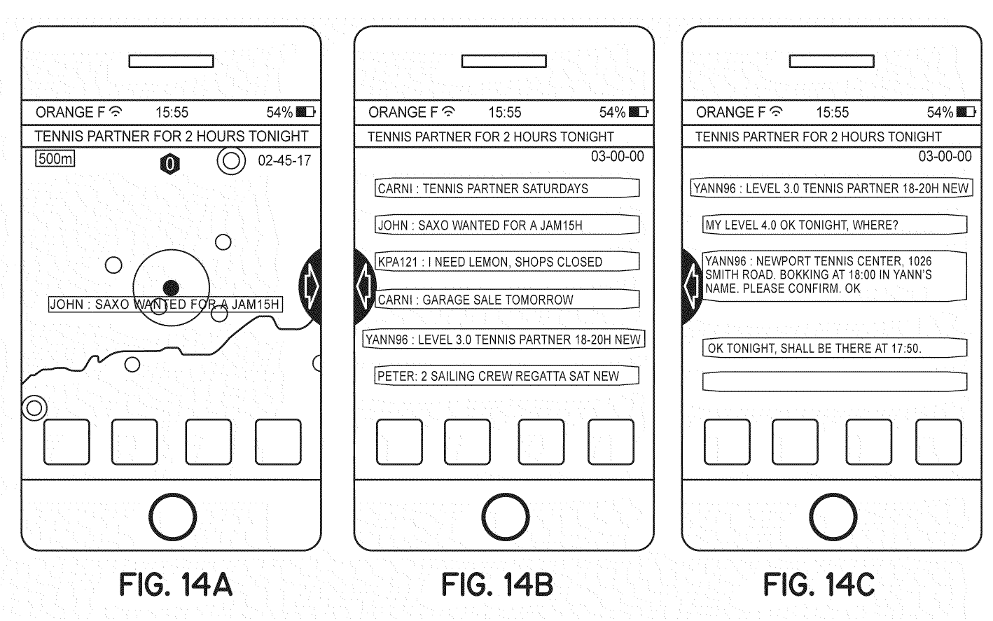

As seen in FIGS. 13A and 13B, the platform 200 provides location data on matched users on the displayed Map, and further (as shown in FIGS. 14A and 14B, discussed below), identifies interests expressed by the matched users. The user may then evaluate this data to determine whether matched users' interests and geo-locations fit his/her preferences, and if not, perform further filtering by adjusting the interest parameter for greater accuracy, or adjusting the geographic area. These adjustments combine to act as a filter of matched users' relevancy, by taking into consideration the number, the geo-locations and the interests of matched users.

As seen in FIG. 13A, the map displays the geo-locations of matched users in the device user's LATIN (brightly colored dots). The dots indicating the matched users' geo-locations may be colored or shaped, to classify these matched users in a very few categories, for instance, discriminating “favorites”, i.e., users with which there have been favorable prior engagements.

The screen further displays the Number of “outside” matched users who are part of the user's LATIN, but are located outside the displayed Map, in a hexagon or other shape icon at the top center of the screen (see 408, FIGS. 4A and 4B).

To display the “outside” matched users' locations, the user can increase the scale of the Map, showing a Map covering a larger area, or use other actions modifying his Map/GA (as described above), to create a new view as seen in FIG. 13B. This may be done until the count of “outside” matched users reduces to zero, indicating all matched users' locations are indicated in the displayed Map.

In the example of FIGS. 13A/13B, the two “outside” matched users identified in FIG. 13A have been brought into the map at the top and bottom by the change of scale to FIG. 13B. The dots of these two users are circled in black in the figure to make them conspicuous.

The home screen of the LATIN App shows the locations of matched users, sharing a common interest, but does not display the details of the interests expressed by the matched users which have been linguistically matched into a LATIN. However, the user can display the interests of all of the matched users in the LATIN in various ways, seen in FIGS. 14A and 14B.

Referring to FIG. 14A, the user make a standard touch-screen gesture, for instance a “tap”, on the dot indicating the geo-location of a matched user in the screen shown in FIG. 13B, to cause a rectangular box to appear over the selected dot, displaying the matched user's log-in and interest, shown in the Figure.

Referring to FIG. 14B, in an alternative embodiment, the user may make a standard touch-screen gesture, e.g. a “tap”, on the tab on the right side of the screen shown in FIG. 13B, to cause a new screen shown in FIG. 14B to appear, which displays the list of all matched users' log-ins and interests. The tab may be color coded (e.g. yellow and blue) to visually cue the user to its connection to the “interest box” 400. From the screen in FIG. 14B, the user can return to the Map at any time by either by a “tap” the tab on the left side of the screen of FIG. 14B, or a “double tap” on a selected message in the screen of FIG. 14B, in which case the display will present the screen of FIG. 14A, with the selected message next to the selected matched user's location dot.

Depending on this information received from the platform on matched users' geo-locations and interests, the user may choose to refine his search for matched users relevant to his search by modifying the definition of his own geographic area and interest. For example, if there are too many matched users in the user's LATIN, the user can more precisely redefine his or her interest, or reduce his or her geographic area, for instance to focus on matched users closer to the user's current location. In contrast, if there are too few users in the user's LATIN, the user can more loosely redefine his/her interest or expand his/her geographic area. By adjusting (/refining) his/her geographic area and interest, a user causes the device to communicate the newly defined GA or interest to the platform, and the platform renews its comparison of GAs and interest, hence including new matched users or excluding former matched users of the LATIN. This feed-back process can continue with successive modifications of the GA and interest by the user, until he or she finds matched users with whom he/she wishes to exchange more information.

It should be noted that the three elements (geographic area, interest and, accessorily, the Session currency) are defined by default, meaning the system works even if the user has not expressly defined them. Consequently, it does not matter what default element, GA or interest, the user expressly defines first; what is practically important is the user's ability to use both the geographic area and the interest as joint filters for relevancy of the contacts he or she expects from a LATIN. The purpose of a LATIN is not necessarily to create a lasting community but to enable its users to immediately interact based upon their matched interests by exchanging information, i.e. by sending or receiving messages.

Once the conditions for being part of a LATIN are fulfilled and users have refined their geographic areas and interests so that matched users fit their preferences for contact, users may exchange messages, as shown in FIG. 15B, step 518 and FIG. 14C. A user can send a message to one matched user, send messages to several matched users, or receive a message from any matched user.

To send a message to one user, the user can select a matched user to whom he wishes to send a message, either by a standard touch-screen gesture (for instance a “tap”) on the interest box surrounding the dot locating the matched user on the Map as seen in FIG. 14A, or by a standard touch-screen gesture (for instance a “tap”) on the selected “log-in and interest box” in the interest list seen in FIG. 14B. In either case, a new screen, seen in FIG. 14C, appears with the user's interest in the interest box (in the example below: “Tennis partner for 2 hours tonight”) and the matched user's log-in and interest in the first box (in the FIG. 14C example, “Yann96: level 3.0 tennis partner 18-20h Newport”).

The user is then ready to message directly with the matched user (in FIG. 14C, Yann96). Both the user and Yann96 can send a message to the other. For example, the user makes a standard touch-screen gesture, for instance a “double tap”, on an empty box at the bottom of the messages, the key board of the device appears and the user can use it to type a message that replaces the default interest in the communication box. The user may otherwise provide the message, for instance by speaking in the device microphone. When the user sends the message, (or, for example, stops inputting a message for more than a short period such as 3 seconds) the message is automatically sent by the device to the platform which immediately relays it to the matched user. A new empty box appears at the bottom of the messages.

The messaging interface is similar to text messaging or instant messaging interfaces which are familiar to mobile device users. Messages are maintained in a transcript list of messages which can be scrolled vertically. The first box with the matched user's log-in and interest remains at the top of the scrollable part of the screen. The exchange of information between users consists in a dialog of “instant messaging” channeled through the platform, with possible additional facilities for SMS or other messaging platforms.

The Application may also allow a user to send, through the platform, a “unicast” communication including a common message to one user, or different messages to each of a selected group of matched users, sent as a succession of unicast messages, or the same message to several selected matched users (“multicast” communication). Multicast communications may be made only to matched users of a LATIN, with, in the present embodiment, two limits: the multicast can be sent only to a restricted area which may be smaller than the geographic area otherwise defined by the user, and the multicast may be done only after one by one selection of the matched users through ticking boxes in the List of Log-ins and interests.

Although messages have various attributes of Short Message Service (SMS) in one embodiment the messages are sent via Internet communications, and not SMS, because SMS is presently only accessible to mobile phones, including smartphones, but generally not to tablets, and messages sent via Internet are at no extra charge whereas SMS messages often carry an extra charge from the mobile carrier. Furthermore, the use of Internet messaging allows the channeling of messages through the platform, which permits controls upon message quantity, duration and the like for enforcement of messaging rules such as described above.

A user receives messages only from matched users in his or her LATIN. It is not necessary to select a matched user from whom messages are to be received; membership in a LATIN is sufficient to receive messages from a matched user. Normally, a user receives all messages sent to him or her by any matched user of the same LATIN, however, a user may establish a “black list” of users from whom he wishes not to receive messages.

A user is informed of the receiving of any message by a popup or logo that appears on the LATIN Application screen, which the user can tap to access messages as well as the list of matched users with respective interests, or can dismiss.

The LATIN System may also support enhanced modes of communication, such as live voice or video calling and inclusion of hyperlinks to media. The instant messaging may support other features, or permit users to offer a links to engage using additional features, such as a voice conversation through VoIP, video conferencing (e.g., FaceTime, Skype) or the like. Such direct voice or video communication is typically subject to the prior agreement of the receiver.

Users may receive messages sent when they are in stand-by, i.e. when they are logged in the System but the Application is working in background (see above). In such a case, a discreet/visual sound alarm signals the message. Similar discreet alarms can signal the arrival of users to a LATIN, changes in expressed interests of users, or other notable events affecting a LATIN. Such alarms would typically use the operating system support for application notices and alarms, and can be controlled or disabled through settings defined in the operating system.

The LATIN App can support various privacy features to address potential privacy concerns that arise from use of the system. For example, one source of concern could be that a user's geo-location is continuously communicated by the platform to matched users during a Session. However, during a Session, a user may have option to instruct the platform to restrict the communication of his or her geo-location to matched users, either, mainly, by “blurring” it, or, to a lesser extent, by restricting its communication to some matched users only.

The “blurring” option does not alter what is delivered to the LATIN platform. The accurate geo-location of a user is quasi continuously communicated to the platform. However, the user, when concerned by the possible misuse of his or her geo-location by matched users, has the “invisible option” to instruct the platform to provide a less detailed location to matched users, making his or her location “invisible” and virtually impossible to pinpoint. The geo-location of a user normally appears as a round colored dot on the map displayed on the screens of matched users. If a user chooses the “invisible option”, the dot corresponding to his geo-location is no longer displayed on the maps shown to matched users. Instead a similarly colored and shape dot appears on the side of the map with a number inside it indicating the number of invisible users of the current LATIN. The invisible option may be best made reciprocal: a user selecting the invisible option is not informed of the geo-location of matched users. This option is offered only to answer an occasional concern of a user, but remains an exception and its use is not encouraged. Also, it must not be used to the advantage of a user who would hide while knowing matched users' geo-locations. The invisible option may not be available for certain sub-applications where geo-location is essential for them to work properly (e.g. taxi users), and the invisible option may not be made available to “Business Users” (e.g., restaurants, hotels) whose locations are a priori deemed essential and cannot be hidden from matched users.

An alternative to the invisible method described above, would be to inform matched users of a user's geo-location within a stated and rounded distance for instance 1000 m. This provides some location security, but could be circumvented by an astute method of triangulation by a matched user moving around the specified area. However, it could maintain privacy if used in conjunction with a varying distance depending on the population density of the area (for instance 100 m in a city but 3 km in the countryside) and while displaying distance randomly varying within ranges.

Another alternative is to restrict the availability of geolocation information to only certain persons. For example, some users could be put on a black-list to prevent communication of geolocation to those persons (and/or prevent any communication through the LATIN platform), or geolocation could be communicated only to users on a white-list. The black list and white list could be defined in a user's LATIN Application, so that a user can exclude somebody known outside the LATIN System, by registering this person's email address on the black-list provided by the Application. A user can also decide to exclude a user while within a LATIN (if for example the person is abusive or otherwise unappealing), by registering a reference of this person on the black-list provided by the Application. The white-list enables a user to restrict connections within a LATIN to pre-identified users. They can be pre-identified individually, or by identification of a group set by the user, which might be Favorites, Friends, Family, Colleagues/Work Acquaintances. This approach can encourage a use of LATIN in which people who connect in LATIN first make contact in real life.

A further protection of privacy is provided in LATIN: the user is allowed to change his or her log-in name at will, in the LATIN App setup menus. Because the log-in chosen by a user is normally disclosed to identify a user to matched users, a user may feel that the continuous use of the same log-in could allow another user to stalk and/or gather information (locations, interests) about a person. This can be avoided by changing log-in. Furthermore, the LATIN system can provide an option permitting a user to request that the System not disclose his log-in to matched users. In such a case a pseudonym is automatically generated by the platform each time the user opens a new Session. The user is informed by the platform of this pseudonym. This pseudonym is displayed to matched users instead of the user's log-in.

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

A “computer,” “computer system,” “host,” “server,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed:

1. A method of facilitating social interaction between users in a mobile computing environment, comprising
obtaining from a plurality of mobile device users seeking connection to other users, via each user's respective mobile device, each user's self-identified interest as to which a connection is sought, and self-identified geographic area within which other users are desired to be engaged for a connection,
comparing the self-identified interests and self-identified geographic areas of at least two users to identify two or more matching users, the matching users having expressed matching interests, and having overlapping geographic areas of interest, and
enabling the two or more matching users to commence communication via their respective mobile devices, to facilitate further social interaction.

2. The method of claim 1 wherein a user self-identifies an interest as to which a connection is sought via a natural language text entry.

3. The method of claim 2 wherein the interests of two users are evaluated in a one or more of a syntactic, lexical and semantic analysis to identify matched users having similar of interests as defined in the analysis.

4. The method of claim 1 wherein one matched user views the self-identified stated interest and the geo-location of another matched user, to determine whether to engage in further social networking.

6. The method of claim 1 wherein matched users engage in social networking by message communication via one or more of Internet messaging, SMS communication, voice and video conferencing.

7. The method of claim 1 wherein a user self-identifies a geographic area of interest.

8. The method of claim 7 wherein a user's location is within the user's self-identified geographic area of interest.

9. The method of claim 7 wherein the user's self-identified geographic area of interest is in an ellipse shape, the user defining a location, shape, and/or orientation of the ellipse.

10. The method of claim 1 wherein prior to the obtaining step, a user's self-identified interest is initialized as a default interest, and a user's geographic area of interest is initialized as a default geographic area relative to the user's location.

11. The method of claim 10 wherein the user defines the default geographic area relative to the user's location.

12. The method of claim 1 wherein the duration of a first user's interaction with the system is limited in time.

13. The method of claim 1 wherein a user changes the user's self-identified interest and the comparing and enabling steps are repeated using the user's new self-identified interest.

14. The method of claim 13 wherein, in a feedback process, a user reviews the interests of matching users and then changes the user's self-identified interest to more specifically state an interest of the user based upon interests of one or more matching users.

15. The method of claim 13 wherein, in a feedback process, a user reviews the interests of matching users and then changes the user's self-identified interest to less specifically state an interest of the user to increase the number of matching users.

16. The method of claim 1 wherein a user changes the user's geographic area, and the comparing and enabling steps are repeated using the user's new geographic area.

17. The method of claim 16 wherein, in a feedback process, a user reviews the locations of users in a first geographic area and then reduces the user's geographic area to focus upon social interaction with users in a particular region of the first geographic area.

18. The method of claim 16 wherein, in a feedback process, a user reviews the users in a first geographic area and then expands the user's geographic area to find additional users for social interaction beyond the first geographic area.
